(19) United States
(12) Patent Application Publication
(10) Pub. No.: US 2011/0131713 A1
(43) Pub. Date: Jun. 9, 2011

(54) HYDRATING BASEBALL CHEST PROTECTORS

(76) Inventors: Olavo DaRosa, Taunton, MA (US); Barbara DaRosa, Taunton, MA (US)

(21) Appl. No.: 12/633,870

(22) Filed: Dec. 9, 2009

(51) Int. Cl. A41D 13/00; B67D 7/84; F41H 1/02

(52) U.S. Cl. 2/463; 222/175; 2/2.5

(57) ABSTRACT

A hydrating chest protector is disclosed having a reservoir for providing hydrating fluid to a wearer of the chest protector without removing the chest protector. The reservoir can be located in a back portion of the chest protector with the tube extending to the front of the protector. The tube provides access to hydrating fluid in the reservoir for drinking. The tube can be protected from impacts from a hardball or softball baseball by a flap attached to the front of the protector. The protector can be used in hardball or softball baseball games by catchers or umpires.

### FIELD

This application relates generally to protective equipment for hardball or softball baseball. In particular, this application relates to chest protectors that provide hydration for the wearer.

### BACKGROUND

Baseball, both hardball and softball, is played by millions of people in the United States and millions more in other countries. Baseball has been played internationally for over 100 years. Catchers in these sports often wear protective gear due to the frequency of balls striking the catcher due to foul tips and errant pitches. In professional baseball and in many other organized leagues, base runners are also allowed to collide with the catcher and the catcher is allowed to block home plate, making protective gear additionally beneficial to the catcher.

A catcher's protective gear is robust enough to absorb baseball strikes over 100 miles per hour without injury or significant discomfort to the catcher. Typical protective gear includes a mask, chest protector, leg guards, and a special glove with significantly more padding than the gloves worn by teammates.

Unless the catcher is likely to be batting, the catcher often leaves a significant amount of the protective gear in place even when the catcher's team is batting. Additionally, playing the position of catcher requires physically demanding repetition of squatting, standing, and throwing. Because of the protective gear and the physical demands of the position, a catcher is particularly susceptible to dehydration compared to other players.

Home plate umpires typically wear protective gear similar to the catcher's gear with a mask and chest protector. An umpire may wear his chest protector under an outer shirt. Because of the protective gear and the fact that the umpire remains on the field at all times during play, umpires are also particularly susceptible to dehydration, having very few opportunities to rest and rehydrate.

### SUMMARY

Embodiments of hydrating chest protectors for catchers and umpires in hardball or softball baseball having hydrating fluid storage and delivery capability are discussed and illustrated. Embodiments of a hydrating chest protector can include a front providing ballistic protection to a catcher or umpire from balls travelling over 100 miles per hour, and a back housing the reservoir. A tube extending from the reservoir to the front of the hydrating chest protector provides easy access to a wearer of the hydrating chest protector without removal of the chest protector. The tube can be in fluid communication with the reservoir through a connector. The tube can be protected by a flap from damage by impacts from balls. The tube can include a nozzle for regulating hydrating fluid flow from the reservoir.

The reservoir can include a port for access to refill or clean the reservoir. The reservoir can also be located in a pocket in the back of the hydrating chest protector, removable through an opening in the back.

In some embodiments, the invention is a hydrating chest protector, comprising a reservoir configured to hold a hydrating fluid, a front having protective material configured to provide ballistic protection to a wearer against impact from a baseball travelling over 100 miles per hour, and a tube for delivering the hydrating fluid from the reservoir to a wearer of the hydrating chest protector, the tube extending from the reservoir to a location easily accessible by the mouth of the wearer.

In some embodiments, the reservoir is located in a portion of the hydrating chest protector configured to contact the back of the wearer. In other embodiments, the reservoir is located in a selectively accessible pocket. In some embodiments, the tube is releasably connected to the reservoir through a connector. Other embodiments further comprise a nozzle connected to a distal end of the tube. In some of these embodiments, the nozzle includes a valve.

In some embodiments, the reservoir includes a port for refilling or cleaning the reservoir. In other embodiments, the reservoir is removable from the front.

In some embodiments, the hydrating chest protector is designed for use by a baseball umpire. Some embodiments further comprise a protective flap providing ballistic protection for the tube against impact by a baseball. In some of these embodiments, the protective flap is movable to provide access to the tube by the wearer.

In some embodiments, the reservoir has a fluid capacity of about 30 oz.

In some embodiments, the invention is a method of hydrating during a baseball game, comprising: providing a hydrating chest protector having a reservoir, opening a flap on a hydrating chest protector to gain access to a tube in fluid communication with the reservoir and, drinking hydrating fluid from the tube.

In some embodiments, the reservoir has a fluid capacity of about 30 oz. In other embodiments, the reservoir is located on a back portion of the hydrating chest protector. In other embodiments, a terminus of the tube is located on the right shoulder of the hydrating chest protector. In other embodiments, wherein one side of the flap is releasably securable to a front of the hydrating chest protector with a hook and loop fastener. In some of these embodiments, the flap protects the tube from damage from a ball impacting the tube.

### BRIEF DESCRIPTION OF THE DRAWINGS

The following description can be better understood in light of Figures, in which:

FIG. 1 is a front-view illustration of an exemplary embodiment of a hydrating chest protector;

FIG. 2 is a rear-view illustration of the hydrating chest protector illustrated in FIG. 1; and

FIG. 3 is an illustration of an exemplary hydrating system;

FIG. 4 is an illustration of an exemplary embodiment of a hydrating chest protector for an umpire.

Together with the following description, the Figures demonstrate and explain the principles of inventive hydrating chest protectors and methods for using and making the hydrating chest protectors. In the Figures, the thickness and configuration of components have been sometimes exaggerated for clarity. Components having the same reference numbers in different Figures represent the same respective components.

### DETAILED DESCRIPTION

The following description supplies specific details to provide a thorough understanding. Nevertheless, the skilled artisan would understand that embodiments of hydrating chest protectors and associated methods of using them can be implemented and used without employing these specific details. Indeed, exemplary embodiments and associated methods can be placed into practice by modifying the illustrated units and associated methods, and can be used in conjunction with any other devices and techniques conventionally used in the industry. For example, while the description below focuses on embodiments of hydrating chest protectors for hardball baseball catchers and umpires, the apparatus and associated methods could be equally applied to other situations, such as chest protectors for softball baseball catchers and umpires in any desirable style.

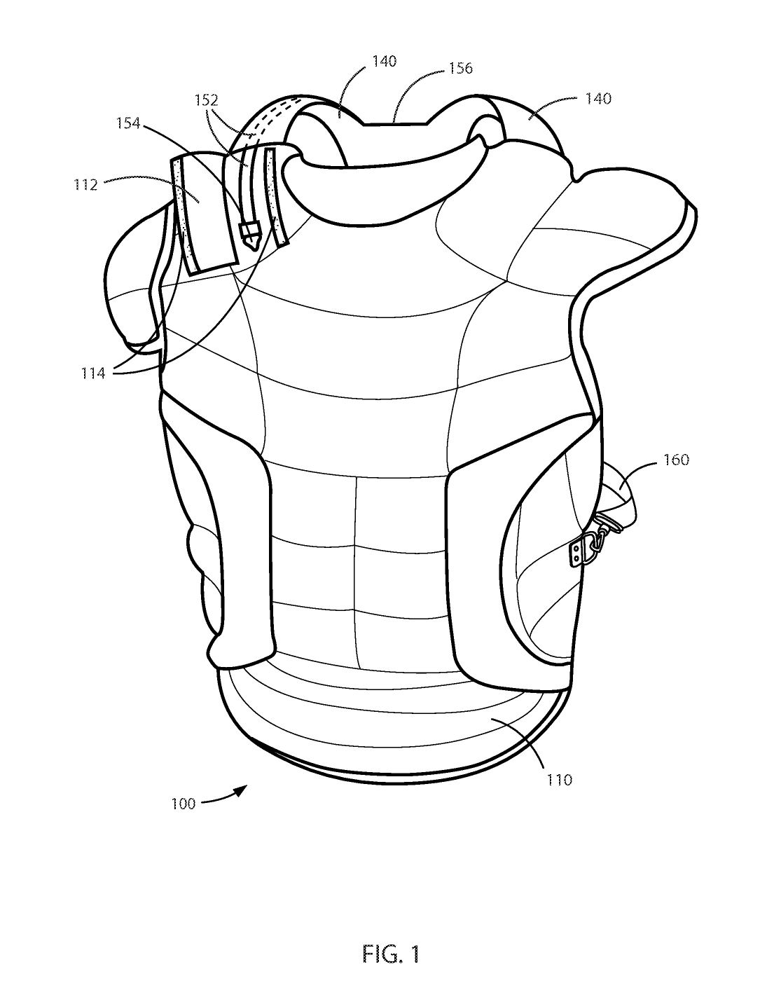

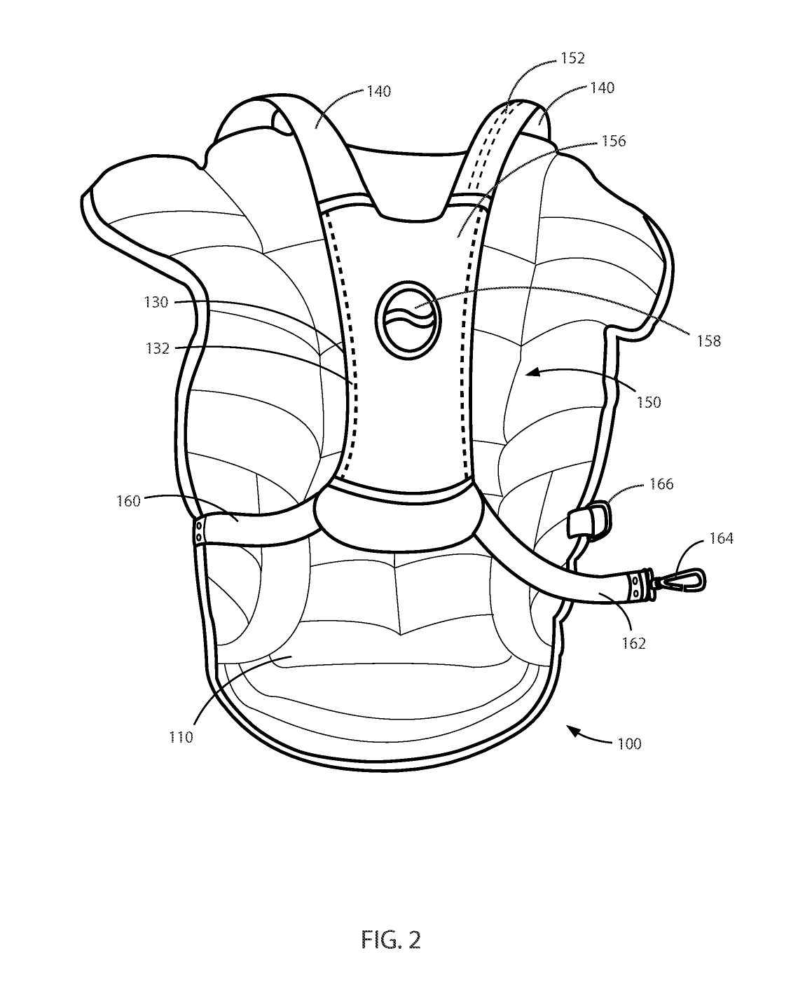

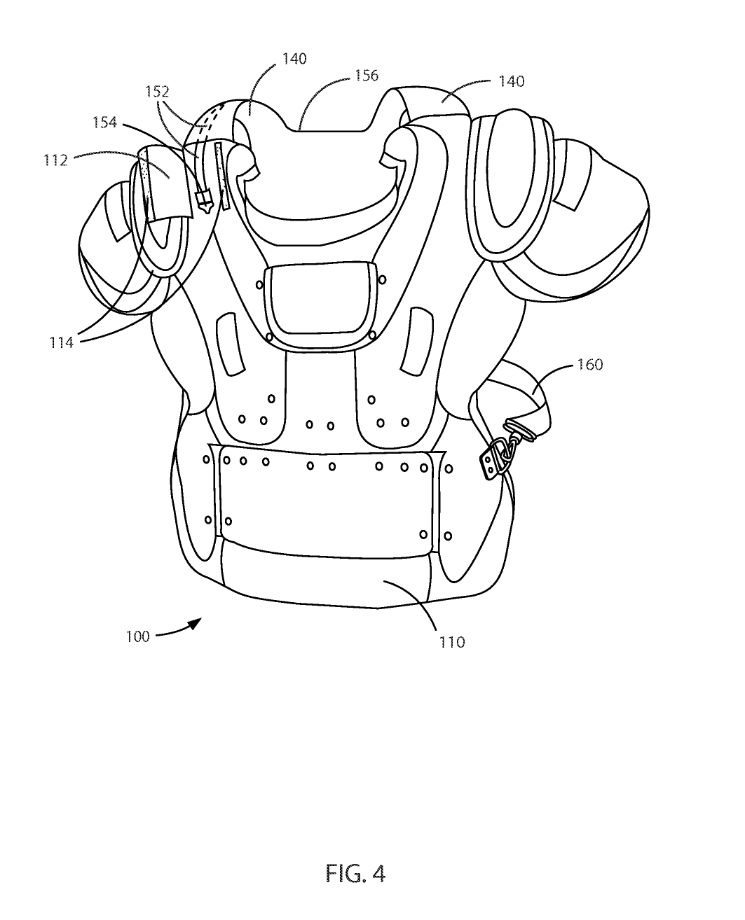

One exemplary hydrating chest protector, generally for a catcher, is illustrated in FIGS. 1-2. FIG. 4 illustrates a different style of chest protector, generally for an umpire, to be worn under an outer shirt of the umpire, and having the same general features and uses as discussed with respect to the chest protector illustrated in FIGS. 1 and 2. Of course any style chest protector may incorporate the elements described and claimed in this document.

In the Figures, hydrating chest protector 100 includes front 110, back 130, shoulder straps 140, hydrating system 150, and straps 160, 162. Front 110 includes padding to protect a wearer from injury when a baseball strikes hydrating chest protector 100. The padding is any padding used in chest protectors. Front 110 may be any design or shape and include any protection features desired by a wearer for use as a baseball chest protector. Flap 112 may be provided for covering tube 152 and nozzle 154 of hydrating system 150. Flap 112 may be made of a flexible material and affixed by one edge to front 110 such that it can be moved to expose and provide access to tube 152 and nozzle 154.

Flap 112 may be held in an easily openable closed position by hook and loop fasteners 114. Similarly, snaps, buttons, or other types of fasteners may be used to hold flap 112 in place. Flap 112 may provide protection to tube 152 and nozzle 154 from damage by ballistic impact from a ball or other object or person. Flap 112 may also provide easy access to tube 152 by lifting flap 112, and moving tube 152 to the mouthof the wearer.

Back 130 includes a pocket for portions of hydrating system 150. The pocket may be selectively accessible through opening 132. Opening 132 may be selectively accessible by opening and closing fasteners used to enclose the pocket using hook and loop fasteners, zipper, snaps, or any other suitable fasteners. Back 130 may be formed for comfort of a wearer and may be formed of any suitable material or combination of materials. In some embodiments, back may be formed such that hydrating system 150 can provide a cooling effect to the back of the wearer by allowing easy energy transfer from the wearer to cold water in hydrating system 150. For example, the layer of back 130 closest to the wearer and separating reservoir 156 from the wearer may be a mesh material, or other light material. Back 130 may also include an opening to allow access to port 158 of hydrating system 150 to allow reservoir 156 to be refilled without removal from back 130 through opening 132.

Shoulder straps 140 may connect front 110 to back 130. Shoulder straps 140 may be formed for comfort of a wearer and made of any suitable material or combination of materials. One or both of shoulder straps 140 may include a channel to hold tube 152 of hydration system 150.

Straps 160, 162 provide connection to the wearer. Strap 162 may be selectively attachable to front 110, providing the wearer with a way to put on and take off hydrating chest protector 100. Strap 162 may include fasteners 164, 166 to secure strap 162 to front 110. Fasteners 164, 166 as shown are a spring hook and ring type fastener. Fasteners 164, 166 may be any suitable fastener such as hook and loop, snaps, buttons, etc. Straps 160, 163 may be adjustable to provide a desired fit of hydrating chest protector 100 for the wearer.

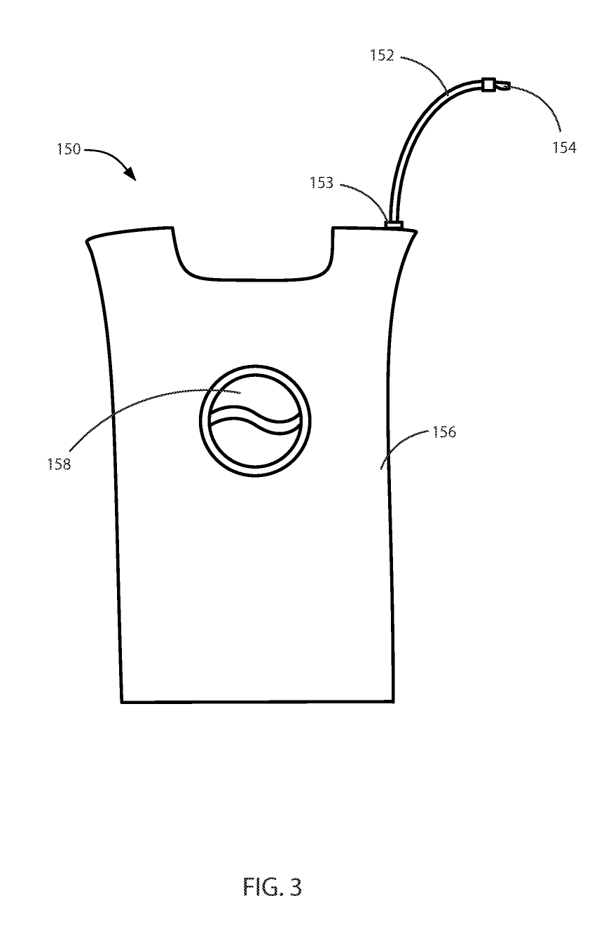

As shown in FIGS. 1, 2, and 4, and particularly in FIG. 3, hydrating system 150 may include tube 152, nozzle 154, connector 153, reservoir 156 and port 158. Tube 152 may extend from reservoir 156 to front 110 to provide hydrating fluid from reservoir 156 to the wearer through nozzle 154 at the convenience of the wearer. Tube may extend to front 110 through a channel in one of shoulder straps 140, as illustrated, or may be secured to a top surface of one or both of shoulder straps 140 with straps, ties, etc. In some embodiments, tube 152 may extend to front 110 under an arm of the wearer.

Nozzle 154 may be a selectively opening nozzle to allow a wearer to open a pathway to hydrating fluid held in reservoir 156 and suck to get hydrating fluid, similar to drinking from a straw, providing regulation of the hydrating fluid flow. Nozzle 154 may include a valve to reduce fluid spills and to provide on-demand access to hydrating fluid. Any type of suitable valve may be used, such as a pinch valve, which opens when pinched, a ball valve, biased gate valve, etc.

Tube 152 may be releasably coupled to reservoir 156 through connector 153. Connector 153 may allow reservoir 156 to be removed from back 130 for cleaning or filling without the need of removing tube 152 from shoulder straps 140. Similarly, tube 152 may be removed for cleaning or replacement without needing to remove reservoir 156 from back 130.

Reservoir 156 may be formed of a deformable material, such as plastic or rubber, such that when hydrating fluid is expended from reservoir 156, the reservoir collapses to a smaller profile, eliminating the need for a pressure or bleeder valve. Reservoir 156 may be formed in a shape to fit in back 130, and to contour to the body of a wearer. Reservoir 156 may be of any size and shape to allow for sufficient hydration without adding significant weight. For example, reservoir 156 may be formed to hold about 30 fluid oz. while comfortably resting between the shoulders blades of the wearer. In other embodiments, reservoir 156 may have a capacity between about 6 and 48 fluid oz., or any other desirable volume.

In some embodiments, a reservoir similar to reservoir 156 may be located in front 110 and shaped accordingly, providing not only hydration, but increased ballistics protection against injury from impacts against front 110. In other embodiments, both front 110 and back 130 may have reservoirs with either a common access to hydrating fluids in both reservoirs, or separate access, such as a tube and nozzle on each side of front 110.

Port 158 may provide access to the interior of reservoir 156 for refilling and cleaning. Port 158 may be accessible when reservoir 156 is in back 130 or removed from hydrating chest protector 100. In some embodiments, reservoir 156 may be quickly replaced with a fresh reservoir for cooling or hydrating purposes without the need for the wearer to remove hydrating chest protector 100.

In some embodiments, back 130 may be integral with reservoir 156, and removable from front 110, shoulder straps 140, straps 160, 162, or some combination of these other elements, for cleaning, replacement, or refilling.

In addition to any previously indicated modification, numerous other variations and alternative arrangements can be devised by those skilled in the art without departing from the spirit and scope of this description, and the appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only, and should not be construed to be limiting in any manner.

1. A hydrating chest protector, comprising:
a reservoir configured to hold a hydrating fluid;
a front having protective material configured to provide ballistic protection to a wearer against impact from a baseball travelling over 100 miles per hour; and
a tube for delivering the hydrating fluid from the reservoir to a wearer of the hydrating chest protector, the tube extending from the reservoir to a location easily accessible by the mouth of the wearer.

2. The hydrating chest protector of claim 1, wherein the reservoir is located in a portion of the hydrating chest protector configured to contact the back of the wearer.

3. The hydrating chest protector of claim 2, wherein the reservoir is located in a selectively accessible pocket.

4. The hydrating chest protector of claim 1, wherein the tube is releasably connected to the reservoir through a connector.

5. The hydrating chest protector of claim 1, further comprising a nozzle connected to a distal end of the tube.

6. The hydrating chest protector of claim 5, wherein the nozzle includes a valve.

7. The hydrating chest protector of claim 1, wherein the reservoir includes a port for refilling or cleaning the reservoir.

8. The hydrating chest protector of claim 1, wherein the reservoir is removable from the front.

9. The hydrating chest protector of claim 1, wherein the hydrating chest protector is designed for use by a baseball umpire.

10. The hydrating chest protector of claim 1, further comprising a protective flap providing ballistic protection for the tube against impact by a baseball.

11. The hydrating chest protector of claim 10, wherein the protective flap is movable to provide access to the tube by the wearer.

12. The hydrating chest protector of claim 1, wherein the reservoir has a fluid capacity of about 30 oz.

13. A method of hydrating during a baseball game, comprising:
providing a hydrating chest protector having a reservoir;
opening a flap on a hydrating chest protector to gain access to a tube in fluid communication with the reservoir; and
drinking hydrating fluid from the tube.

14. The method of claim 13, wherein the reservoir has a fluid capacity of about 30 oz.

15. The method of claim 13, wherein the reservoir is located on a back portion of the hydrating chest protector.

16. The method of claim 15, wherein a terminus of the tube is located on theright shoulder of the hydrating chest protector.

17. The method of claim 13, wherein one side of the flap is releasably securable to a front of the hydrating chest protector with a hook and loop fastener.

18. The method of claim 13, wherein the flap protects the tube from damage from a ball impacting the tube.
